(19) United States
(12) Patent Application Publication
(10) Pub. No.: US 2026/0240257 A1
(43) Pub. Date: Aug. 20, 2026

(54) ELECTRONIC ATOMIZATION APPARATUS AND CONTROL METHOD THEREFOR

(71) Applicant: SHENZHEN FIRST UNION TECHNOLOGY CO., LTD., Shenzhen, Guangdong (CN)

(72) Inventors: Linjian HUANG, Shenzhen, Guangdong (CN); Zhongli XU, Shenzhen, Guangdong (CN); Yonghai LI, Shenzhen, Guangdong (CN)

(73) Assignee: SHENZHEN FIRST UNION TECHNOLOGY CO., LTD., Shenzhen, Guangdong (CN)

(21) Appl. No.: 19/161,458

(22) PCT Filed: Feb. 21, 2024
(86) PCT No.: PCT/CN2024/077887

§ 371 Date: Sep. 2, 2025

(30) Foreign Application Priority Data
Mar. 2, 2023 (CN) 202310234558.5

(51) Int. Cl. A24F 40/57; A24F 40/10; A24F 40/42; A24F 40/465; H05B 6/06; H05B 6/10

(52) U.S. Cl. CPC A24F 40/57; A24F 40/10; A24F 40/42; A24F 40/465; H05B 6/06; H05B 6/108

(57) ABSTRACT

An electronic atomization apparatus and a control method thereof are provided. The electronic atomization apparatus includes a resonant circuit; a susceptor; and a controller. The controller is configured to provide the resonant circuit with a basic pulse signal and multiple reference pulse signals whose frequencies are offset from the basic pulse signal, and obtain multiple resonant parameter values from the resonant circuit; and select one reference pulse signal based on comparison of the resonant parameter values; and the controller being further configured to output the selected reference pulse signal to the resonant circuit during an operating period of the resonant circuit. According to the apparatus and the method, one reference pulse signal is selected from the reference pulse signals whose frequencies are offset from the basic pulse signal, to output the selected reference pulse signal to the resonant circuit during the operating period of the resonant circuit.

### CROSS-REFERENCE TO RELATED APPLICATIONS

This application claims priority to Chinese Patent Application No. 202310234558.5, entitled “ELECTRONIC ATOMIZATION APPARATUS AND CONTROL METHOD THEREFOR” and filed with the China National Intellectual Property Administration on Mar. 2, 2023, which is incorporated herein by reference in its entirety.

### TECHNICAL FIELD

This application relates to the field of electronic atomization technologies, and in particular, to an electronic atomization apparatus and a control method therefor.

### BACKGROUND

An exemplary electronic atomization apparatus usually includes a liquid substrate. The liquid substrate is heated by a heating element. For example, a susceptor generates heat in a changing magnetic field generated by a resonant circuit, so that the liquid substrate is heated to be vaporized and generate an inhalable aerosol.

A controller provides a corresponding operating frequency to the resonant circuit based on a clock signal generated by an internal RC oscillator of the controller. However, due to different production processes, frequencies of the RC oscillators of chips may be different. A temperature also affects precision of the RC oscillator. Because the operating frequency of the resonant circuit is relatively high, an error of the RC oscillator causes a relatively high frequency offset, affecting an atomization rate and an inhalation experience.

### SUMMARY

This application aims to provide an electronic atomization apparatus and a control method therefor, to resolve a problem of a frequency offset of an operating frequency of a resonant circuit caused by an error of an internal RC oscillator of a controller.

According to an aspect of this application, an electronic atomization apparatus is provided, including:
a resonant circuit, configured to generate a changing magnetic field;
a susceptor, configured to be penetrated by the changing magnetic field to generate heat, to heat an aerosol-forming substrate to generate an aerosol; and
a controller, configured to: provide the resonant circuit with a basic pulse signal and a plurality of reference pulse signals whose frequencies are offset from the basic pulse signal, and obtain a plurality of resonant parameter values from the resonant circuit; and select one reference pulse signal based on comparison of the plurality of resonant parameter values; and the controller being further configured to output the selected reference pulse signal to the resonant circuit during an operating period of the resonant circuit.

According to another aspect of this application, a control method of an electronic atomization apparatus is provided, where the electronic atomization apparatus includes a resonant circuit, configured to generate a changing magnetic field; and a susceptor, configured to be penetrated by the changing magnetic field to generate heat, to heat an aerosol-forming substrate to generate an aerosol; and the method includes:
providing the resonant circuit with a basic pulse signal and a plurality of reference pulse signals whose frequencies are offset from the basic pulse signal, and obtaining a plurality of resonant parameter values from the resonant circuit; and
selecting one reference pulse signal based on comparison of the plurality of resonant parameter values, to output the selected reference pulse signal to the resonant circuit during an operating period of the resonant circuit.

According to the foregoing electronic atomization apparatus and the control method therefor, one reference pulse signal is selected from the plurality of reference pulse signals whose frequencies are offset from the basic pulse signal, to output the selected reference pulse signal to the resonant circuit during the operating period of the resonant circuit, thereby preventing an atomization rate and inhalation experience from being affected by a frequency offset caused by an error of an RC oscillator.

### BRIEF DESCRIPTION OF THE DRAWINGS

One or more embodiments are exemplarily described with reference to corresponding figures in the accompanying drawings, and the descriptions do not constitute a limitation to the embodiments. Elements in the accompanying drawings that have same reference numerals are represented as similar elements, and unless otherwise particularly stated, the figures in the accompanying drawings are not drawn to scale.

FIG. 1 is a schematic diagram of an electronic atomization apparatus according to an implementation of this application;

FIG. 2 is a schematic diagram of a switch circuit and a resonant circuit according to an implementation of this application;

FIG. 3 is a schematic diagram of adjusting a value of a fine-tuning bit according to an implementation of this application; and

FIG. 4 is a schematic diagram of a control method of an electronic atomization apparatus according to an implementation of this application.

### DETAILED DESCRIPTION

For ease of understanding of this application, this application is described in further detail below with reference to the accompanying drawings and specific implementations. It should be noted that, when an element is expressed as “being fixed to” another element, the element may be directly on the another element, or one or more intermediate elements may exist between the element and the another element. When an element is expressed as “being connected to” another element, the element may be directly connected to the another element, or one or more intermediate elements may exist between the element and the another element. The terms “upper”, “lower”, “left”, “right”, “inner”, “outer”, and similar expressions used in this specification are merely used for an illustrative purpose.

Unless otherwise defined, meanings of all technical and scientific terms used in this specification are the same as those usually understood by a person skilled in the technical field to which this application belongs. In this specification, the terms used in this specification of this application are merely intended to describe objectives of the specific implementations, and are not intended to limit this application. The term “and/or” used in this specification includes any or all combinations of one or more related listed items.

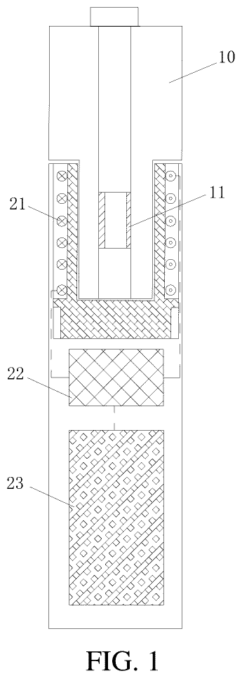

FIG. 1 is a schematic diagram of an electronic atomization apparatus according to an implementation of this application.

As shown in FIG. 1, an electronic atomization apparatus 100 includes an atomizer 10 and a power supply assembly 20. In an example, the atomizer 10 is removably connected to the power supply assembly 20, and the atomizer 10 and the power supply assembly 20 may be connected in a buckle connection manner, a magnetic connection manner, and the like. In an example, it is also feasible that the atomizer 10 and the power supply assembly 20 are integrally formed.

The atomizer 10 includes a susceptor 11 and a liquid storage cavity (not shown in the figure). The liquid storage cavity is configured to store an atomizable liquid substrate. The susceptor 11 is configured to be inductively coupled to an inductor 21, and generate heat when being penetrated by a changing magnetic field, to heat the liquid substrate to generate an aerosol for inhalation.

Preferably, the liquid substrate includes a tobacco-containing material, where the tobacco-containing material includes a volatile tobacco flavor compound released from the liquid substrate during heating. Alternatively or in addition, the liquid substrate may include a non-tobacco material. The liquid substrate may include water, ethanolor or another solution, a plant extract, a nicotine solution, or a natural or artificial flavoring agent. Preferably, the liquid substrate further includes an aerosol forming agent. Examples of a suitable aerosol forming agent are glycerol and propylene glycol.

Generally, the susceptor 11 may be made of at least one of the following materials: aluminum, iron, nickel, copper, bronze, cobalt, ordinary carbon steel, stainless steel, ferritic stainless steel, martensitic stainless steel, or austenitic stainless steel.

Further, the atomizer 10 further includes a liquid transfer unit. The liquid transfer unit may be, for example, cotton fiber, metal fiber, ceramic fiber, glass fiber, porous ceramic, or the like. The liquid transfer unit may transfer the liquid substrate stored in the liquid storage cavity to the susceptor 11 through a capillary action.

The power supply assembly 20 includes an inductor 21, a circuit 22 and a battery cell 23.

The inductor 21 generates a changing magnetic field under an alternating current, and the inductor 21 includes, but is not limited to, an induction coil.

The battery cell 23 provides electric power for operating the electronic atomization apparatus 100. The battery cell 23 may be a rechargeable battery cell or a disposable battery cell.

The circuit 22 may control an overall operation of the electronic atomization apparatus 100. The circuit 22 not only controls operations of the battery cell 23 and the inductor 21, but also controls operations of other elements in the electronic atomization apparatus 100.

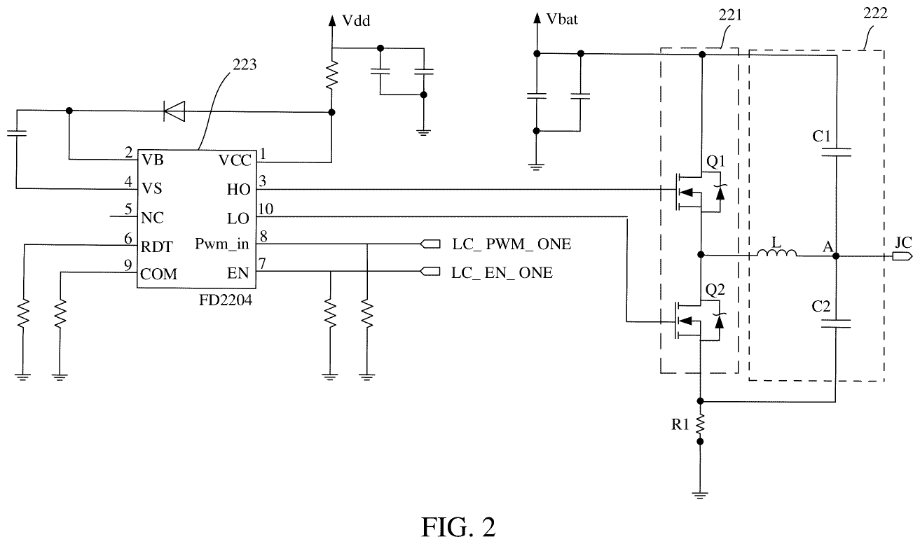

FIG. 2 shows a schematic diagram of basic components of an embodiment of the circuit 22.

The circuit 22 includes the following components.

An inverter includes a switch circuit 221 and a resonant circuit 222, where
the switch circuit 221 includes a half-bridge circuit formed by transistors; and the transistors include, but are not limited to, IGBT transistors, MOS transistors, or the like. As shown in FIG. 2, the half-bridge circuit includes a transistor Q1 and a transistor Q2, which are configured to enable the resonant circuit 222 to generate resonance through alternating turn-on and turn-off of the two transistors.

The resonant circuit 222 is formed by the inductor 21 (shown by L in the figure), a first capacitor C1, and a second capacitor C2. The resonant circuit 222 is configured to form an alternating current flowing through the inductor L in a resonance process, to enable the inductor L to generate an alternating magnetic field, so as to induce the susceptor 11 to generate heat.

A driver 223 is configured to control the transistor Q1 and the transistor Q2 to be turned on and turned on and turned off alternately according to a control signal of a controller (not shown in the figure). The controller may alternatively be a part of the circuit 22, and preferably, an MCU is used.

As an example, the driver 223 is a transistor driver of a commonly used FD2204 model, which is controlled by the controller by using a pulse width modulation (PWM) signal. Generally, a frequency of the pulse signal ranges from 800 KHz to 2 Mhz. According to a pulse width of the pulse signal, a third I/O port and a tenth I/O port of the transistor driver alternately send a high level/a low level, to drive the transistor Q1 and the transistor Q2 alternatively and maintain respective turn-on time, so as to control the resonant circuit 222 to generate resonance.

In connection, the transistor Q1 and the transistor Q2 are connected in series, and the first capacitor C1 and the second capacitor C2 are connected in series. One end of the inductor L is electrically connected between the transistor Q1 and the transistor Q2, and the other end of the inductor L is electrically connected between the first capacitor C1 and the second capacitor C2.

Specifically, a first end of the first capacitor C1 is connected to a positive electrode of the battery cell 23, and a second end of the first capacitor C1 is connected to a first end of the second capacitor C2; a second end of the second capacitor C2 is grounded through a resistor R1; and a first end of the transistor Q1 is connected to the positive electrode of the battery cell 23, a second end of the transistor Q1 is connected to a first end of the transistor Q2, and a second end of the transistor Q2 is grounded through the resistor R1; certainly, control ends of the transistor Q1 and the transistor Q2 are both connected to the driver 223, to be turned on and turned off under driving of the driver 223; and a first end of the inductor L is connected to the second end of the transistor Q1, and a second end of the inductor L is connected to the second end of the first capacitor C1.

In terms of hardware selection of a resonant device, withstand voltages of the first capacitor C1, the second capacitor C2, the transistor Q1, and the transistor Q2 are far greater than an output voltage of the battery cell 23. For example, in a common implementation, the output voltage of the used battery cell 23 is approximately 4 V, and the withstand voltages of the first capacitor C1, the second capacitor C2, the transistor Q1, and the transistor Q2 are within 100 V.

In a switching state of the transistor Q1 and the transistor Q2, in the resonant circuit 222 of the foregoing structure, connection states between the first capacitor C1 and the inductor L and between the second capacitor C2 and the inductor L are changed. When the transistor Q1 is turned on and the transistor Q2 is turned off, the first capacitor C1 and the inductor L jointly form a closed LC series circuit, and the second capacitor C2 and inductor L form an LC series circuit with two ends respectively connected to the positive electrode and a negative electrode of the battery cell 23; and when the transistor Q1 is turned off and the transistor Q2 is turned on, formed circuits are opposite to the foregoing state, where the first capacitor C1 and the inductor L form an LC series circuit with two ends respectively connected to the positive electrode and the negative electrode of the battery cell 23, and the second capacitor C2 and the inductor L jointly form a closed LC series circuit. In respective different states, the first capacitor C1 and the second capacitor C2 can both form the respective LC series circuits with the inductor L. However, during an oscillation process of the respective LC series circuits, directions and cycles of generated currents that flow through the inductor L are the same, to jointly form the alternating current that flows through the inductor L.

When the controller drives, by using the driver 223, the transistor Q1 and the transistor Q2 to be alternately turned on and turned off, the inductor L, the first capacitor C1, and the second capacitor C2 operate in a resonance state, and a central resonance point A generates sine oscillation with a voltage amplitude of Q times Vin, where Q is a quality factor of the inductor L, the first capacitor C1, and the second capacitor C2, and Vin is an input voltage or a power supply voltage of the switch circuit 221. With a constant Vin, a larger Q value indicates a higher amplitude of a resonant voltage at the point A, a larger magnetic induction intensity β coupled to the susceptor 11, a higher induction electromotive force received by the susceptor 11, and a faster heat generating speed. A resonant frequency may improve a quality factor of a resonant circuit. With a constant Vin, a higher resonant frequency indicates a larger Q value. However, a high frequency has a high requirement on a response speed of the device, and it is difficult to control costs.

Generally, a clock signal of the controller is generated by an internal RC oscillator. For example, the clock signal is generated by an RC oscillator with a reference frequency of 8 MHz. Based on the clock signal, the controller may output a pulse signal of a specific frequency in a manner of frequency multiplication first and frequency division second, to drive the transistor Q1 and the transistor Q2 by using the driver 223, so as to control the resonant circuit 222 to generate resonance. When the frequency of the pulse signal output by the controller is consistent with the resonant frequency of the resonant circuit, the quality factor of the resonant circuit 222 reaches the highest, and the resonant voltage at the point A reaches the maximum. However, when frequency multiplication is first performed and frequency division is then performed on the clock signal with the frequency of 8 MHz, it is difficult to obtain the frequency of the pulse signal which is consistent with the resonant frequency. For example, in the resonant circuit 222, an inductance value of the inductor 21 is 0.543 pH, and capacitance values of the first capacitor C1 and the second capacitor C2 are 4.7 nF. Therefore, it may be determined that the resonant frequency of the resonant circuit 222 is 1.56 MHz Referring to the following table, frequency multiplication by 6 times is first performed on the clock signal with the reference frequency of 8 MHz to obtain a frequency of 48 MHz, and frequency division by 30 times is then performed to obtain an output frequency of 1.6 MHz. If an output frequency obtained by performing frequency multiplication by 6 times first and frequency division by 31 times then on the clock signal with the reference frequency of 8 MHz is 1.548 MHz, the output frequency obtained by the foregoing theoretical calculation deviates from a target resonant frequency of 1.56 MHz.

In addition, an error exists in the device. For example, the internal RC oscillator of the controller also has a positive error or a negative error, and a temperature also has a certain impact on precision of the RC oscillator. For example, a typical precision value of the RC oscillator is ±1% (the temperature is approximately 25° C.), and when the temperature ranges from −40° C. to 105° C., the precision value of the RC oscillator expands to ±3%. Therefore, the frequency of the clock signal output by the controller deviates from the reference frequency of 8 MHz. For the foregoing deviation, reference may be made to the following table (it is assumed that the typical precision value of the RC oscillator is ±1%):

| | | | Reference | Reference | Resonant |
|---|---|---|---|---|---|
| / | | | frequency +1% | frequency −1% | frequency |
| Reference frequency | 8 | MHz | 8.080 MHz | 7.920 MHz | 1.56 MHz |
| Frequency multiplication | 48 | MHz | 48.48 MHz | 47.52 MHz | |
| by 6 times | | | | | |
| Frequency division by 30 | 1.6 | MHz | 1.616 MHz | 1.584 MHz | |
| times | | | | | |
| Frequency division by 31 | 1.548 | MHz | 1.563 MHz | 1.532 MHz | |
| times | | | | | |

Based on the foregoing problem, in an example, the controller is configured to: provide the resonant circuit 222 with a basic pulse signal and a plurality of reference pulse signals whose frequencies are offset from the basic pulse signal, and obtain a plurality of resonant parameter values from the resonant circuit 222; and select one reference pulse signal based on comparison of the plurality of resonant parameter values; and the controller is further configured to output the selected reference pulse signal to the resonant circuit 222 during an operating period of the resonant circuit 222.

In this example, a frequency of the basic pulse signal is an inherent frequency of the internal RC oscillator. The frequencies of the reference pulse signals are offset from the frequency of the basic pulse signal. The resonant parameter value includes at least one of a resonant voltage, a resonant current, a resonant frequency, and a quality factor.

In a preferred implementation, the controller includes a clock control register, where the clock control register has a plurality of fine-tuning bits in a one-to-one correspondence with the reference pulse signals. The controller invokes the fine-tuning bit to output a reference pulse signal of a corresponding frequency. Frequency offsets between reference pulse signals represented by adjacent fine-tuning bits are the same.

By using an STM32 controller as an example, a value of a HSITRIM[4:0] bit of a clock control register RCC_CR of the STM32 controller may be set by a user, where the value is set in a range from 0 to 31, and a default value is 16. A HSICAL [7:0] bit of the clock control register RCC_CR stores a factory calibration value. With the value of HSICAL, the controller may fine-tune the frequency of the internal RC oscillator. A fine-tuning step length between a former HSICAL step and a latter HSICAL step is approximately 40 kHz.

In a specific example, the following steps may be performed to obtain the plurality of resonant parameter values from the resonant circuit:

First, a value of the fine-tuning bit is determined. For example, the value of the fine-tuning bit may be any value from 0 to 31.

In this step, an initial value of the HSITRIM[4:0] bit of the clock control register RCC_CR may be used, and the value of the HSITRIM[4:0] bit is adjusted in a specific manner. For example:

In a manner, it is assumed that the initial value of the HSITRIM[4:0] bit is 0, and the value of the HSITRIM[4:0] bit may be gradually increased to 31 in an ascending manner. Similarly, it is also feasible to decrease the value of the HSITRIM[4:0] bit in a descending manner.

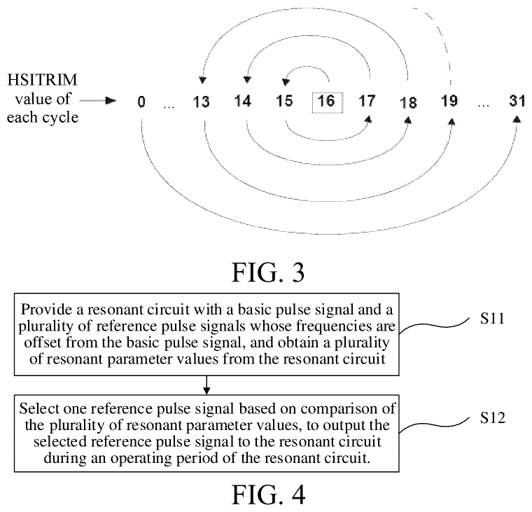

In another manner, as shown in FIG. 3, the value of the HSITRIM[4:0] bit may be adjusted in a manner similar to a spring ring. It is assumed that the initial value of the HSITRIM[4:0] bit is 16. In this case, a corresponding frequency of the pulse signal of the controller is an inherent frequency of the internal RC oscillator, such as 8 MHz; first, the value of the HSITRIM[4:0] bit is adjusted to 15, and in this case, the corresponding frequency of the pulse signal of the controller is negatively offset by 40 kHz based on the inherent frequency of the internal RC oscillator; then the value of the HSITRIM[4:0] bit is adjusted to 17, and in this case, the corresponding frequency of the pulse signal of the controller is positively offset by 40 kHz based on the inherent frequency of the internal RC oscillator; then the value of the HSITRIM[4:0] bit is adjusted to 14, and in this case, the corresponding frequency of the pulse signal of the controller is negatively offset by 80 kHz based on the inherent frequency of the internal RC oscillator; then the value of the HSITRIM[4:0] bit is adjusted to 18, and in this case, the corresponding frequency of the pulse signal of the controller is positively offset by 80 kHz based on the inherent frequency of the internal RC oscillator; and the rest can be deduced by analogy until the value is adjusted to 31.

Then, offset adjustment is performed on the frequency of the pulse signal of the controller based on the determined value of the fine-tuning bit, to control the resonant circuit 222 to operate at the adjusted frequency of the pulse signal and generate a corresponding resonant parameter value.

Then, the resonant parameter value is recorded.

Finally, the foregoing steps are repeated, to obtain a plurality of recorded data. The obtained plurality of recorded data may be stored in a memory of the controller, or may be stored in another memory such as an external memory.

In an example, the controller is configured to select a reference pulse signal corresponding to a maximum value in the plurality of resonant parameter values.

In a preferred implementation, the controller selects the maximum resonant parameter value and the reference pulse signal corresponding to the maximum resonant parameter value from the plurality of recorded data. The controller outputs the selected reference pulse signal to the resonant circuit during an operating period of the resonant circuit. In this case, the frequency of the pulse signal of the resonant circuit 222 is very close to the resonant frequency, or is consistent with the resonant frequency.

By using the resonant voltage as an example, the controller is configured to: provide the resonant circuit 222 with a basic pulse signal and a plurality of reference pulse signals whose frequencies are offset from the basic pulse signal, and obtain a plurality of resonant voltages from the resonant circuit 222; and select a reference pulse signal corresponding to a maximum value in the plurality of resonant voltages based on comparison of the plurality of resonant voltages; and the controller is further configured to output the selected reference pulse signal to the resonant circuit 222 during the operating period of the resonant circuit 222.

In this preferred implementation, the controller is configured to perform frequency multiplication calculation and/or frequency division calculation on a frequency of the selected reference pulse signal, to obtain an operating frequency provided to the resonant circuit. For example, frequency multiplication calculation is first performed, and then frequency division calculation is performed, to obtain the operating frequency provided to the resonant circuit.

In an example, the controller obtains, by using a detection circuit, a resonant parameter value generated when the resonant circuit operates under the reference pulse signal.

By using the resonant voltage as an example, the detection circuit includes an RC integrating circuit and a resistor voltage dividing circuit. After passing through the RC integrating circuit and the resistor voltage dividing circuit in sequence, a resonant voltage at a resonance point A is input to an ADC sampling end of the controller.

As shown in FIG. 4, this application further provides a control method of an electronic atomization apparatus. For a structure of the electronic atomization apparatus, reference may be made to the foregoing descriptions, and details are not described herein again.

The method includes the following steps.

S11: Provide a resonant circuit with a basic pulse signal and a plurality of reference pulse signals whose frequencies are offset from the basic pulse signal, and obtain a plurality of resonant parameter values from the resonant circuit.

S12: Select one reference pulse signal based on comparison of the plurality of resonant parameter values, to output the selected reference pulse signal to the resonant circuit during an operating period of the resonant circuit.

In an example, the resonant parameter value includes at least one of a resonant voltage, a resonant current, a resonant frequency, and a quality factor.

In an example, a reference pulse signal corresponding to a maximum value in the plurality of resonant parameter values is selected.

In an example, the method further includes:
determining a value of a fine-tuning bit, and performing offset adjustment on a frequency of a pulse signal of the controller based on the determined value of the fine-tuning bit, to control the resonant circuit to operate at the adjusted frequency of the pulse signal and generate a corresponding resonant parameter value; and recording the resonant parameter value.

In an example, frequency multiplication calculation and/or frequency division calculation are performed on a frequency of the selected reference pulse signal, to obtain an operating frequency provided to the resonant circuit.

In an example, the operating frequency of the pulse signal provided to the resonant circuit is controlled to range from 800 KHz to 2 Mhz.

In an example, frequency multiplication calculation is first performed on the frequency of the selected reference pulse signal, and frequency division calculation is then performed on the frequency of the selected reference pulse signal, to obtain the operating frequency.

It should be noted that, the foregoing examples are only described by using an LCC series resonant circuit as an example. In another example, an LC series resonant circuit (including but not limited to a half-bridge series resonant circuit and a full-bridge series resonant circuit), an LC parallel resonant circuit, or the like may alternatively be used for description.

It should be noted that, the specification of this application and the accompanying drawings thereof illustrate preferred embodiments of this application. However, this application may be implemented in various different forms, and is not limited to the embodiments described in this specification. These embodiments are not intended to be an additional limitation on the content of this application, and are described for the purpose of providing a more thorough and comprehensive understanding of the content disclosed in this application. Moreover, the foregoing technical features are further combined to form various embodiments not listed above, and all such embodiments shall be construed as falling within the scope of the specification of this application. Further, a person of ordinary skill in the art may make improvements or modifications according to the foregoing descriptions, and all the improvements and modifications shall fall within the protection scope of the appended claims of this application.

What is claimed is:

1. An electronic atomization apparatus, comprising:
a resonant circuit, configured to generate a changing magnetic field;
a susceptor, configured to be penetrated by the changing magnetic field to generate heat, to heat an aerosol-forming substrate to generate an aerosol; and
a controller, configured to: provide the resonant circuit with a basic pulse signal and a plurality of reference pulse signals whose frequencies are offset from the basic pulse signal, and obtain a plurality of resonant parameter values from the resonant circuit; and select one reference pulse signal based on comparison of the plurality of resonant parameter values; and the controller being further configured to output the selected reference pulse signal to the resonant circuit during an operating period of the resonant circuit.

2. The electronic atomization apparatus according to claim 1, wherein the resonant parameter value comprises at least one of a resonant voltage, a resonant current, a resonant frequency, and a quality factor.

3. The electronic atomization apparatus according to claim 1, wherein the controller is configured to select a reference pulse signal corresponding to a maximum value in the plurality of resonant parameter values.

4. The electronic atomization apparatus according to claim 1, wherein the controller comprises a clock control register, wherein the clock control register has a plurality of fine-tuning bits in a one-to-one correspondence with the reference pulse signals, and the controller invokes the fine-tuning bit to output a reference pulse signal of a corresponding frequency.

5. The electronic atomization apparatus according to claim 4, wherein frequency offsets between reference pulse signals represented by adjacent fine-tuning bits are the same.

6. The electronic atomization apparatus according to claim 4, wherein the controller is configured to: determine a value of the fine-tuning bit, and perform offset adjustment on a frequency of the pulse signal of the controller based on the determined value of the fine-tuning bit, to control the resonant circuit to operate at an adjusted frequency of the pulse signal and generate a corresponding resonant parameter value; and record the resonant parameter value.

7. The electronic atomization apparatus according to claim 1, wherein the electronic atomization apparatus further comprises a detection circuit, configured to detect the resonant parameter values generated by the resonant circuit; and
the controller obtains, by using the detection circuit, the resonant parameter values generated by the resonant circuit operating under the reference pulse signals.

8. The electronic atomization apparatus according to claim 1, wherein the controller is configured to perform frequency multiplication calculation and/or frequency division calculation on a frequency of the selected reference pulse signal, to obtain an operating frequency provided to the resonant circuit.

9. The electronic atomization apparatus according to claim 8, wherein the operating frequency provided by the controller to the resonant circuit ranges from 800 KHz to 2 Mhz.

10. The electronic atomization apparatus according to claim 8, wherein the controller is configured to first perform frequency multiplication calculation and then perform frequency division calculation on the frequency of the selected reference pulse signal, to obtain the operating frequency.

11. The electronic atomization apparatus according to claim 1, wherein the electronic atomization apparatus further comprises a liquid storage cavity in fluid communication with the susceptor, wherein the liquid storage cavity is configured to store an atomizable liquid substrate; and
the susceptor is configured to be penetrated by the changing magnetic field to generate heat, to heat the liquid substrate stored in the liquid storage cavity.

12. The electronic atomization apparatus according to claim 1, wherein the electronic atomization apparatus further comprises a switch circuit, wherein the switch circuit comprises a transistor; the resonant circuit comprises an inductor and a capacitor; and
the transistor is configured to be alternately turned on and turned off under driving of a pulse signal, so that an alternating current flows through the inductor in the resonant circuit and generates the changing magnetic field.

13. The electronic atomization apparatus according to claim 12, wherein the inductor and the capacitor are connected in series.

14. The electronic atomization apparatus according to claim 12, wherein the transistor comprises a first transistor and a second transistor, and the capacitor comprises a first capacitor and a second capacitor;
the first transistor and the second transistor are connected in series, and the first capacitor and the second capacitor are connected in series; and one end of the inductor is electrically connected between the first transistor and the second transistor, and the other end of the inductor is electrically connected between the first capacitor and the second capacitor.

15. A control method of an electronic atomization apparatus, wherein the electronic atomization apparatus comprises a resonant circuit, configured to generate a changing magnetic field; and a susceptor, configured to be penetrated by the changing magnetic field to generate heat, to heat an aerosol-forming substrate to generate an aerosol; and the method comprises:
providing the resonant circuit with a basic pulse signal and a plurality of reference pulse signals whose frequencies are offset from the basic pulse signal, and obtaining a plurality of resonant parameter values from the resonant circuit; and
selecting one reference pulse signal based on comparison of the plurality of resonant parameter values, to output the selected reference pulse signal to the resonant circuit during an operating period of the resonant circuit.
